(19) United States
(12) Patent Application Publication
(10) Pub. No.: US 2016/0090912 A1
(43) Pub. Date: Mar. 31, 2016

(54) INLET PARTICLE SEPARATOR SYSTEM

(71) Applicant: General Electric Company, Schenectady, NY (US)

(72) Inventors: Narendra Digamber Joshi, Schenectady, NY (US); Ross Hartley Kenyon, Brookfield, CT (US); Andrei Tristan Evulet, Mason, OH (US)

(21) Appl. No.: 14/958,971

(22) Filed: Dec. 4, 2015

Related U.S. Application Data
(63) Continuation-in-part of application No. 12/957,282, filed on Nov. 30, 2010.

(51) Int. Cl. F02C 7/052; B01D 45/04

(52) U.S. Cl. CPC F02C 7/052; B01D 45/04

(57) ABSTRACT

An inlet particle separator system coupled to an engine having an engine exhaust is presented. The inlet particle separator system includes an axial flow separator for separating air from an engine inlet into a first flow of substantially contaminated air and a second flow of substantially clean air. The inlet particle separator system further includes a scavenge subsystem in flow communication with the axial flow separator for receiving the first flow of substantially contaminated air. Furthermore, the inlet particle separator system includes a fluidic device including a first inlet and an exhaust, where the fluidic device is configured to accelerate the first flow of substantially contaminated air through the scavenge subsystem and emit the first flow of substantially contaminated air via the exhaust of the fluidic device, wherein the exhaust of the fluidic device is different from an exhaust of the engine.

### CROSS-REFERENCE TO RELATED APPLICATIONS

This application is a continuation-in-part of U.S. application Ser. No. 12/957282 filed on Nov. 30, 2010, the entire contents of which are hereby incorporated by reference.

### BACKGROUND

The invention relates generally to an inlet particle separator system and more particularly to a system and method of operating the inlet particle separator system having a fluidic device.

Generally, aircraft engines are susceptible to damage from foreign particulate matter introduced into air inlets of such engines. Mostly, vertical takeoff and landing (VTOL) aircraft engines such as helicopter gas turbine engines are vulnerable to damage due to smaller particulate matter like sand or ice. These VTOL aircrafts operate at various conditions where substantial quantities of sand or ice may become entrained in intake air supplied to the gas turbine engine and can cause substantial damage. For example, a helicopter engine operating at low altitudes over a desert looses performance rapidly due to erosion of the engine blades due to ingestion of sand and dust particles. In order to solve this problem, various inlet particle separator (IPS) systems have been developed for use with different kinds of gas turbine engines.

One means of providing highly effective separation is to mount a blower system with an engine inlet that centrifuges the inlet air entrained with particles before the air enters the engine core. Once the air is accelerated to a high centrifugal velocity with the particles entrained therein, relatively clean air can be drawn from an inner portion of the centrifugal flow into the core engine itself. Because of its density, the extraneous matter itself cannot be drawn radially inwardly as quickly as the air and instead the particles will tend to follow their original trajectory around an outer radius into a collection chamber. Also, a well-designed IPS system using a mechanical blower may achieve a separation efficiency (ηₛₑₚ) above 90%. Air flow rates through the mechanical blower may be between 10% and 30% of the air flow rates through the engine core. However, such IPS system having the blower system has severe performance disadvantages due to constant operation during flight even in absence of particulate matter at higher altitudes. Further, due to constant running of IPS blower, there is large consumption of power during flight at high altitudes. Also, the IPS system with a blower increases the overall cost in addition to weight of the IPS system, thereby, affecting the performance of the gas turbine engine. Furthermore, the life of the blower system is limited and requires frequent maintenance and potentially less expensive while delivering identical or better performance.

Therefore, there is an ongoing need for an inlet particle separator system that does away with a blower and is more efficient and reliable.

### BRIEF DESCRIPTION

In accordance with one embodiment of the invention, an inlet particle separator system is presented. The inlet particle separator system is configured to be coupled to an engine. The inlet particle separator system includes an axial flow separator for separating air from an engine inlet into a first flow of substantially contaminated air and a second flow of substantially clean air. The inlet particle separator system further includes a scavenge subsystem in flow communication with the axial flow separator for receiving the first flow of substantially contaminated air. Furthermore, the inlet particle separator system includes a fluidic device including a first inlet and an exhaust, where the fluidic device is configured to accelerate the first flow of substantially contaminated air through the scavenge subsystem and emit the first flow of substantially contaminated air via the exhaust of the fluidic device, wherein the exhaust of the fluidic device is different from an exhaust of the engine.

In accordance with another embodiment of the invention, a fluidic device is presented. The fluidic device includes a first inlet for receiving a first flow of substantially contaminated air and a second inlet for receiving a compressed air. The fluidic device further includes an annular chamber for receiving the compressed air via the second inlet. Furthermore, the fluidic device includes a ring nozzle in fluid communication with the annular chamber for receiving the compressed air and supplying a jet of the compressed air into a conduit defined by the fluidic device, where the jet of the compressed air into the conduit is admitted such that the first flow of substantially contaminated air is accelerated and emitted via an exhaust of the fluidic device.

### DRAWINGS

These and other features, aspects, and advantages of the present invention will become better understood when the following detailed description is read with reference to the accompanying drawings in which like characters represent like parts throughout the drawings, wherein:

FIG. 1 is an elevation view, partly cut away, of an inlet particle separator system, in accordance with certain aspects of the present technique;

FIG. 2 is a sectional view of a fluidic device of the inlet particle separator system, in accordance with certain aspects of the present technique; and

FIG. 3 is a flow chart of a method of operating an inlet particle separator system, in accordance with certain aspects of the present technique.

### DETAILED DESCRIPTION

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters are not exclusive of other parameters of the disclosed embodiments.

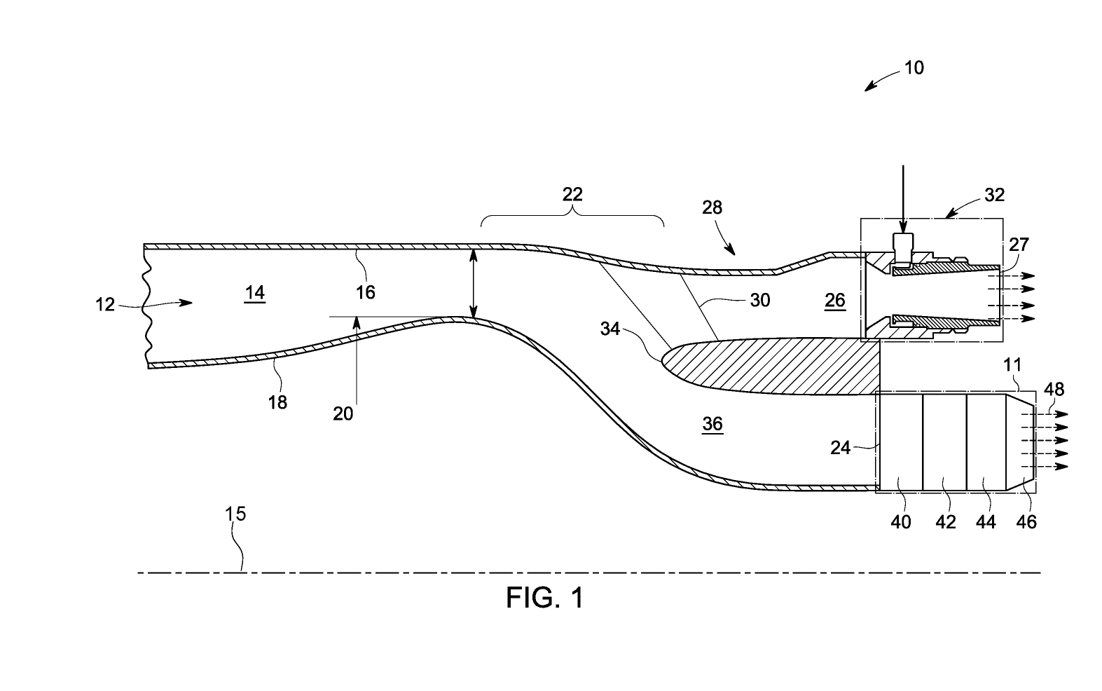

FIG. 1 shows an inlet particle separator system 10 in accordance with an embodiment of the present technique. The inlet particle separator system 10 is designed to be mounted on the front end of an engine 11. For example, the engine 11 may be a gas turbine engine, such as, but not limited to, an aircraft engine. The engine 11 may include a compressor 40, a combustor 42, and a turbine 44 having an exhaust 46. Reference numeral 15 represents an engine's centerline.

In one embodiment, the inlet particle separator system 10 is a detachable unit. The function of the inlet particle separator 10 is to separate extraneous matter from inlet air in the engine 11 and direct the resulting substantially cleaned air into a core of the engine 11. In operation, ambient air is drawn into the inlet particle separator 10 through an annular inlet 12. The incoming air flows through the annular inlet 12 and an intake passageway section 14. The outer boundary of the intake passageway section 14 is formed by an outer casing 16. The inner boundary of the passageway section 14 is formed by a hub section 18. As shown, the diameter of the hub section 18 gradually increases in the downstream direction along the intake passageway 14. In a non-limiting manner, the degree to which the hub section 18 increases in diameter through the intake passageway section 14 may vary.

The diameter of the hub section 18 (with reference to the engine centerline 15) continues to gradually increase from the annular inlet 12 in the downstream direction until the hub section 18 reaches a point of maximum diameter 20, whereafter the hub diameter quickly drops off or decreases. This portion of the inlet particle separator 10 with decreasing diameter is referred to as an axial separator 22. The diameter of the axial separator 22 may decrease gradually or steadily, and regularly or intermittently depending on a desirable shape of the axial separator 22. In at least a portion of the axial separator 22, extraneous matter present in the engine inlet air physically separates thereby forming a first flow of substantially contaminated air and a second flow of substantially clean air. The second flow of substantially clean air eventually enters the engine 11. Further, momentum of the solid particles constituting the extraneous matter prevents the particles from turning with the second flow of substantially clean air and continues with the first flow of substantially contaminated air in the passageway or duct 26. Thus, the first flow of substantially contaminated air is received by the fluidic device 32. Separation of extraneous matter in the axial separator 22 is facilitated by rapidly accelerating the inlet air 12 past the point of hub maximum diameter 20, and thereafter rapidly turning the air radially inwardly towards the engine 11.

In some embodiments, the engine 11 may be disposed such that the second flow of substantially clean air is received at an inlet of the compressor 40 of the engine 11. The compressor 40 may generally draw the second flow of substantially clean air radially inwardly without excessive losses in flow efficiency of the substantially clean air. The substantially clean air may be compressed by the compressor 40 for combustion into the combustor 42 with one or more fuels. The combustion of the fuels and the compressed air into the combustor 42 facilitates operation of the turbine 44. Combustion residues, after being passed through the turbine 44, may exit from the exhaust 46 as an exhaust gas 48.

Further, the extraneous matter entrained in the inlet air flow is made up of solid particles and is naturally denser (i.e., having greater mass per unit of volume) than the gas flow stream within which it is entrained. Because it is denser, the momentum of the extraneous matter is likely to cause the particles to have a greater tendency to continue in their original direction of flow and not make the sharp turn radially inwardly after the maximum hub diameter 20 unlike the air itself. Therefore, the extraneous matter (e.g., in the form of the first flow of substantially contaminated air) tends to continue in an axial direction and enter a passageway or duct 26.

Before being drawn inwards into the duct 26, the first flow of substantially contaminated air enters a scavenge subsystem 28. Further, a splitter nose 34 separates the flow path into the scavenge system 28 and a core engine flow path 36. The scavenge subsystem 28 includes scavenge vanes 30. In some embodiments, the scavenge vanes 30 are used to hold the splitter nose 34 in place. To achieve high separation efficiency, the inlet particle separator system 10 has a flow path that is designed such that the extraneous matter entrained in the incoming air does not enter the inlet 24 of the compressor (i.e., inlet of the engine 11). Additionally, the scavenge subsystem 28 is designed to reduce the probability of extraneous matter bouncing back into the compressor inlet 24 after striking structural elements of the scavenge system 28.

Furthermore, the inlet particle separator system 10 includes the fluidic device 32. The fluidic device 32 may be disposed in fluid communication with the scavenge subsystem 28. For example, the fluidic device 32 may be disposed at any desired location on the passageway or duct 26 such that the fluidic device 32 receives the first flow of substantially contaminated air and accelerates the first flow of substantially contaminated air. It is to be noted that the passageway or duct 26 is different from the core engine flow path 36.

In one embodiment, the fluidic device 32 is a coanda-effect flow amplifier. Consequently, the fluid flow through duct 26 increases the likelihood of the particles to enter the scavenge subsystem 28. In one embodiment, the fluid flow rates through duct 26, expressed as a fraction of fluid flow rates entering the compressor inlet through the core engine flow path 36, may be in the range of about 5% to about 30%. Further, separation efficiencies above 90% may also be achieved with the inlet particle separator system 10

Due to the coanda-effect, the first flow of the substantially contaminated air enters into the scavenge subsystem 28 and subsequently gets accelerated due to the presence of the fluidic device 32. The accelerated first flow of the substantially contaminated air exits from an exhaust 27 of the fluidic device 32. It is to be noted that the exhaust 27 of the fluidic device 32 is different from the exhaust 46 of the engine 11. Accordingly, the inlet particle separator system 10 facilitates the first flow of substantially contaminated air being emitted at a location (e.g., the exhaust 27) different from the exhaust 46 of the engine 11. Advantageously, such a separate exhaust of the substantially contaminated air may result in a robust operation of the engine 11. For example, with the presence of the fluidic device 32, an aircraft engine such as the engine 11 may be operated even with dusty / contaminated air.

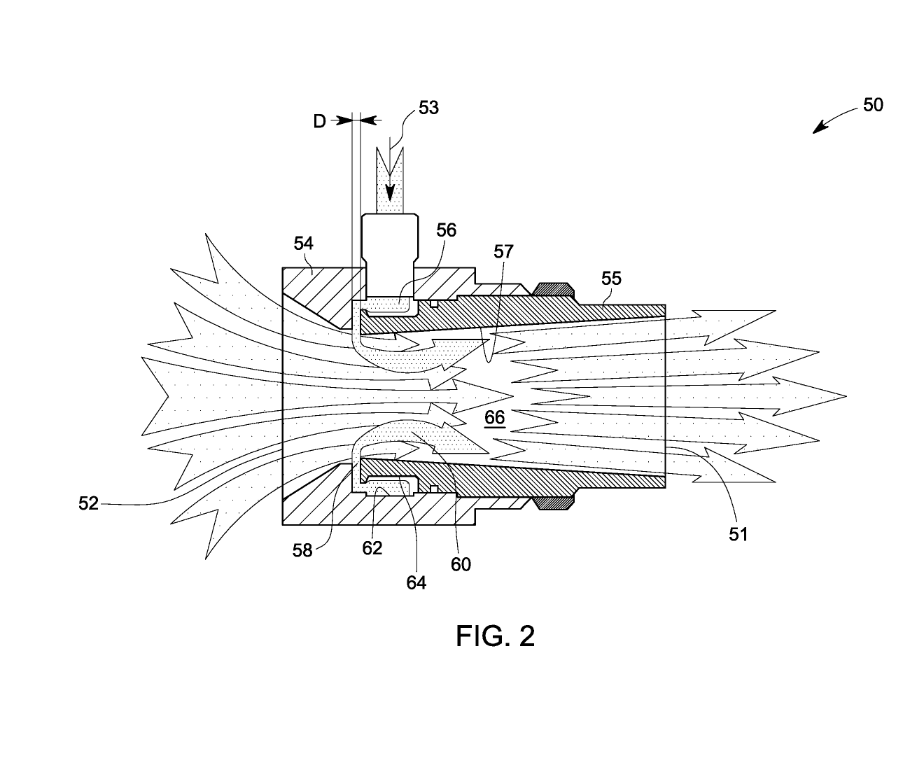

FIG. 2 shows a sectional view of a fluidic device 50 in accordance with an embodiment of the present technique. The fluidic device 50 may represent an example embodiment of the fluidic device 32 of FIG. 1. The fluidic device 50 is mounted at any desired location on a passageway or duct (shown as the duct 26 in FIG. 1) for receiving the first flow of substantially contaminated air. In one embodiment, the fluidic device 50 is mounted at an optimum location on the passageway or duct (shown as the duct 26 in FIG. 1) so as to achieve a high separation efficiency. The fluidic device 50 may include a first inlet 52 for receiving the first flow of substantially contaminated air. In some embodiments, the first inlet 52 may receive the first flow of substantially contaminated air from a scavenge subsystem such as the scavenge subsystem 28 of FIG. 1. The first flow of substantially contaminated air that is received at the first inlet 52 may be emitted via an exhaust 51 of the fluidic device 50. In one embodiment, the exhaust 51 may be different form an engine exhaust, such as the exhaust 46 of FIG. 1.

In some embodiments, the fluidic device 50 may include a second inlet 53 for receiving a compressed air from the engine 11. The second inlet 53 may be configured to be in fluid communication with an annular chamber 56 (described later) for supplying the compressed air thereto. The compressed air may be received by the second inlet 53 from one or more of a compressor (such as the compressor 40), combustor (such as the combustor 42), or a turbine (such as the turbine 44) of the engine 11 of FIG. 1. For example, the compressed air may be supplied from a bleed port or anti-ice port of a compressor 40 or a combustor 42 of the engine 11. In one embodiment, the second inlet 53 is in communication with the bleed port that is provided at a thermodynamically desired location of the compressor 40. Alternatively, the compressed air may also be supplied from the turbine 44 of the engine 11 to the second inlet 53.

In some embodiments, the fluidic device 50 may include the annular chamber 56 for receiving the compressed air via the second inlet 53. Although not illustrated for this embodiment, the fluidic device 50 may be formed using a single body, where the annular chamber 56 may be integral to the body of the fluidic device 50. In another embodiment, the fluidic device 50 may be formed using a plurality of body sections, for example, an outer body 54 and an inner body 55. At least a portion of the inner body 55 may be disposed within at least a portion of the outer body 54. Further, the outer body 54 may include a slot 62 and the inner body may include a slot 64. The slots 62 and 64 may be formed annularly in the outer body and the inner body, respectively. Further, the outer body 54 and the inner body 55 may be arranged such that the annular chamber 56 is defined by the slots 62 and 64. In yet another embodiment, the annular chamber 56 may be integral to any of the outer body 54 or the inner body 55.

In some embodiments, the fluidic device 50 may also include a ring nozzle 58. In one embodiment, when the fluidic device 50 is be formed using a single body, the ring nozzle 58 may be defined by an annular slot formed in the body of the fluidic device 50, where the slot has an opening in an inner wall 57 of the fluidic device. While, in another embodiment, the ring nozzle 58 may be defined by the outer body 54 and the inner body 55 of the fluidic device 50. For example, the inner body 55 may be positioned at an axial distance D from the outer body 54, such that the space between the outer body 54 and the inner body 55 defines the ring nozzle 58. In some embodiments, the outer body 54 and the inner body 55 may be arranged such that the ring nozzle 58 is formed about an entrance of the first inlet 52 of the fluidic device 50. Additionally, the outer body 54 and the inner body 55 may be arranged such that the inner wall 57 of the inner body 55 defines a conduit 66.

During operation, the compressed air may be received into the annular chamber 56 and subsequently admitted through the ring nozzle 58 at a high velocity into the conduit 66 carrying the first flow of substantially contaminated air. The fluid flow rates through the second inlet 53, expressed as a fraction of fluid flow rate through the first inlet 52 of the fluidic device 50, may be in the range of about 3% to about 30%.

It is to be noted that the inner wall 57 of the fluidic device 50 has a coanda profile 60 near the ring nozzle 58 towards the exhaust 51. The jet of compressed air flowing out of the ring nozzle 58 adheres to the coanda profile 60. For example, the jet of compressed air flowing out of the ring nozzle 58 adheres to the inner wall 57. Such a profile of the jet of compressed air flowing out of the ring nozzle 58 results in formation of a low-pressure area at the center of the first inlet 52. The formation of the low-pressure area at the center of the first inlet 52 may induce an accelerated first flow of the substantially contaminated air in the conduit 66 along with the jet of compressed air towards the exhaust 51. The accelerated first flow of substantially contaminated air further causes the particles such as sand or dust or ice to be transported in a radially outward direction and collected in a collection chamber (not shown). In one embodiment, the collection chamber may be disposed downstream of the exhaust 51.

In one embodiment, the fluidic device 50 includes one or more valves for controlling the flow of the compressed air into the annular chamber 56 based on a quantity of particulate matter in the engine inlet air. In another embodiment, the fluidic device 50 includes a flow control device (not shown) operatively coupled to the one or more valves. In one example, the flow control device may control the flow of the compressed air into the conduit 66 based on a quantity of the particulate matter in the engine inlet air by controlling operation of the one or more valves. This is advantageous as the inlet particle separator system 10 (shown in FIG. 1) attains the ability to be easily shut off or modulated when there is little or no particulate matter present in the engine inlet air, thereby increasing the engine operation efficiency. In some non-limiting examples, quantity of the particulate matter in the engine inlet may be determined optical absorption spectroscopy technique such as laser absorption measurement analysis. In one embodiment, the fluidic device 50 is activated or deactivated using a bleed valve or a damper located at a bleed port of the compressor, such as the compressor 40 of FIG. 1.

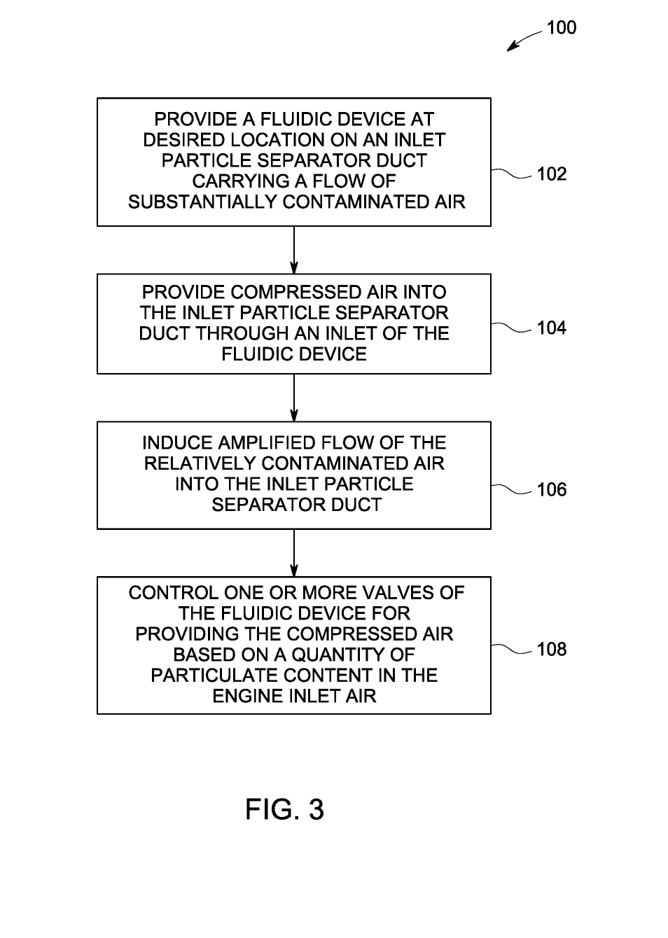

FIG. 3 shows a flow chart 100 of a method of operating an inlet particle separator system of an engine, in accordance with an embodiment of the present technique. At step 102, the method includes providing a fluidic device at a desired location on an inlet particle separator duct carrying a first flow of substantially contaminated air. The fluidic device enables inducting air first through a scavenge subsystem and further into the inlet particle separator duct carrying the first flow of substantially contaminated air. At step 104, the method includes providing the compressed air into a conduit through a ring nozzle of the fluidic device. Further, at step 106, the method includes inducing amplified/accelerated first flow of the substantially contaminated air into the inlet particle separator duct. At step 108, the method includes controlling one or more valves of the fluidic device for providing the compressed air based on a quantity of particulate content in the engine inlet air. In one embodiment, the one or more valves include a bleed port valve or a damper valve. The controlling of the one or more valves includes modulating the valves or shutting off the fluidic device depending upon the presence of a determined amount of particles or absence of particulate matter in the engine inlet air respectively.

Advantageously, the present method and system enables the operation of the inlet particle separator system based on the quantity of contamination in the engine inlet air. Therefore, at high altitudes and in absence of extraneous matter, the system can be modulated or easily deactivated to save power and increase engine operation efficiency. Furthermore, the fluidic device of the inlet particle separator system causes additional separation of the particulate matter that is centrifuged in a radially outward direction due to accelerated first flow of substantially contaminated air. Also, the fluidic device instead of the blower in the inlet particle separator system is more economical and requires less maintenance since the device is more tolerant to sand particles passing through it unlike a blower that suffers from the problem of blade wear. Moreover, the weight of the present system is lighter and positively affects the efficiency of an aircraft engine. Further advantages of the present technique include an improved engine packaging whereby, the inlet particle separator system is installed away from the gearbox.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An inlet particle separator system configured to be coupled to an engine, the inlet particle separator system comprising:
an axial flow separator for separating air from an engine inlet into a first flow of substantially contaminated air and a second flow of substantially clean air;
a scavenge subsystem in fluid communication with the axial flow separator for receiving the first flow of substantially contaminated air; and
a fluidic device comprising a first inlet and an exhaust, wherein the fluidic device is disposed in flow communication with the scavenge subsystem, wherein the fluidic device is configured to accelerate the first flow of substantially contaminated air through the scavenge subsystem and emit the first flow of substantially contaminated air via the exhaust of the fluidic device,
wherein the exhaust of the fluidic device is different from an exhaust of the engine.

2. The inlet particle separator system of claim 1, wherein the fluidic device is disposed such that the first inlet of the fluidic device receives the first flow of substantially contaminated air from the scavenge subsystem.

3. The inlet particle separator system of claim 1, wherein the fluidic device further comprises a second inlet for receiving a compressed air from the engine.

4. The inlet particle separator system of claim 3, wherein the second inlet receives the compressed air from one or more of a compressor, combustor, or a turbine of the engine.

5. The inlet particle separator system of claim 3, wherein the fluidic device further comprises an annular chamber for receiving the compressed air from the engine via the second inlet, and wherein the annular chamber is defined within a body of the fluidic device.

6. The inlet particle separator system of claim 5, wherein the annular chamber is defined by an outer body and an inner body of the fluidic device.

7. The inlet particle separator system of claim 5, wherein the fluidic device further comprises a ring nozzle in fluid communication with the annular chamber for supplying a jet of the compressed air from the annular chamber into a conduit defined by the fluidic device.

8. The inlet particle separator system of claim 7, wherein the ring nozzle is formed in the body of the fluidic device.

9. The inlet particle separator system of claim 7, wherein the ring nozzle is defined by an outer body and an inner body of the fluidic device.

10. The inlet particle separator system of claim 7, wherein the jet of the compressed air is supplied by the ring nozzle such that the compressed air adheres to an inner wall of the fluidic device.

11. The inlet particle separator system of claim 1, further comprising one or more control valves for modulating operation of the fluidic device.

12. The inlet particle separator system of claim 11, wherein the one or more control valves comprises a bleed valve or a damper located at a bleed port of the compressor for activating or deactivating the fluidic device.

13. The inlet particle separator system of claim 11, further comprising a flow control device operatively coupled to the one or more control valves, wherein the flow control device controls the operation of the one or more control valves based on a quantity of the particulate matter.

14. A fluidic device, comprising:
a first inlet for receiving a first flow of substantially contaminated air;
a second inlet for receiving a compressed air;
an annular chamber for receiving the compressed air via the second inlet; and
a ring nozzle in fluid communication with the annular chamber for receiving the compressed air and supplying a jet of the compressed air into a conduit defined by the fluidic device, wherein the jet of the compressed air into the conduit is admitted such that the first flow of substantially contaminated air is accelerated and emitted via an exhaust of the fluidic device.

15. The fluidic device of claim 14, wherein the annular chamber and the ring nozzle are formed integral to a body of the fluidic device.

16. The fluidic device of claim 14, wherein the fluidic device further comprises an outer body and an inner body, wherein the annular chamber and the ring nozzle are defined by the outer body and the inner body.

17. The fluidic device of claim 14, wherein the second inlet receives the compressed air from a compressor of an engine coupled to the fluidic device.

18. The fluidic device of claim 14, wherein the second inlet receives the compressed air from one or more of a combustor or a turbine of an engine coupled to the fluidic device.
